(19) United States
(12) Patent Application Publication
(10) Pub. No.: US 2026/0237397 A1
(43) Pub. Date: Aug. 13, 2026

(54) AUDIO INPUT SELECTION AND MIXING USING ARTIFICIAL INTELLIGENCE

(71) Applicant: Zoom Communications, Inc., San Jose, CA (US)

(72) Inventors: Yifeng Fan, Foster City, CA (US); Qiang Gao, Pineville, NC (US); Cheng Lun Hu, Singapore (SG); Zhaofeng Jia, Saratoga, CA (US); Thi Ngoc Tho Nguyen, Singapore (SG); Shiwei Wang, Hefei (CN)

(73) Assignee: Zoom Communications, Inc., San Jose, CA (US)

(21) Appl. No.: 19/529,800

(22) Filed: Feb. 4, 2026

Related U.S. Application Data
(60) Provisional application No. 63/758,186, filed on Feb. 13, 2025.

(51) Int. Cl. G10L 25/30; H04L 12/18

(52) U.S. Cl. CPC G10L 25/30; H04L 12/1813

(57) ABSTRACT

Techniques for audio input selection and mixing using artificial intelligence are disclosed. In an example method, an integrated video conference system receives a plurality of audio streams from a plurality of audio capture devices. The system receives a plurality of audio quality measures from the plurality of audio capture devices, each audio capture device generating audio quality measures based on the audio stream captured by an audio input device. The system generates a plurality of selection probabilities comprising determining a selection probability for the plurality of audio quality measures. The system selects one or more highest quality audio streams of the plurality of audio streams based on the plurality of selection probabilities. The system generates an output audio stream comprising aggregating the one or more highest quality audio streams based on the corresponding selection probabilities.

### CROSS-REFERENCE TO RELATED APPLICATION

This application claims priority to provisional application U.S. Ser. No. 63/758,186 entitled “Audio Input Selection and Mixing Using Artificial Intelligence” and filed on Feb. 13, 2025, the entire disclosure of which is incorporated herein by reference for any purpose.

### FIELD

The present application generally relates to audio engineering and artificial intelligence (“AI”), and more particularly relates to techniques for audio input selection and mixing using artificial intelligence.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for techniques for audio input selection and mixing using artificial intelligence, according to some aspects of the present disclosure.

FIG. 4 shows an example of a system implementing audio input selection and mixing using artificial intelligence, according to some aspects of the present disclosure.

FIG. 5 shows an example implementation of a feature generator for audio input selection and mixing using artificial intelligence, according to some aspects of the present disclosure.

FIG. 6 shows an example implementation of a trained machine learning (ML) model, according to some examples of the present disclosure.

FIG. 7 shows a flowchart of an example method for implementing audio input selection and mixing using artificial intelligence, according to some aspects of the present disclosure.

FIG. 8 shows another flowchart of an example method for implementing audio input selection and mixing using artificial intelligence, according to some aspects of the present disclosure.

FIG. 9 shows an example computing device suitable for use in example systems or methods for providing techniques for audio input selection and mixing using artificial intelligence, according to some aspects of the present disclosure.

### DETAILED DESCRIPTION

Examples are described herein in the context of techniques for audio input selection and mixing using artificial intelligence. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferencing is an indispensable and integral part of modern living, in both enterprise and personal contexts. While a basic use case involving disparate participants each at a remote location is common, hybrid video conferencing, in which some participants are physically together, in-office while some others are remote, is increasingly common. For example, some participants may join a video conference, together, in conference room, while some other participants join the video conference from personal client devices at remote locations.

Integrated video conferencing systems such as the “Zoom Room” product by Zoom Communications, Inc. can provide an all-in-one platform for high-definition video meetings by integrating software and hardware for both audio and video. Such integrated video conferencing systems are designed to meet the needs of hybrid work environments and may be situated in conference rooms or other public meeting places. Integrated video conferencing systems have a diverse spectrum of use cases and are suitable for diverse locations such as offices, classrooms, or homes. Integrated video conferencing systems can allow participants to join video conferences either on-site or remotely. For example, in a typical integrated video conferencing system session, some individuals may gather in a conference room equipped with an integrated video conferencing system, while others connect virtually using a client device executing video conference client software.

Audio configuring and engineering when using integrated video conferencing systems presents several distinct challenges. For example, an integrated video conferencing system may feature built-in microphones, positioned either near the video output device (e.g., television or monitor) or on a nearby table, to capture audio from participants in the conference room. However, generating high-quality audio for the remote participants from the audio captured in the conference room can be challenging in certain scenarios. For example, if the participants using an integrated video conferencing system are seated far from the microphones, the resultant generated audio captured from the various microphones may be degraded due to factors such as reverberation, signal scattering, or decay during transmission. For instance, for a meeting participant seated far from a microphone, the microphone may capture more sound reflecting off the walls and ceiling than the participant's voice directly, causing remote attendees to hear an echoey, indistinct version of what was said.

To tackle this challenge, some existing integrated video conferencing systems can enable participants to use their personal devices, such as laptops and smartphones, as audio input devices. In some cases, the hardware and software executing on such devices can implement certain sound engineering technologies (e.g., acoustic echo cancellation, noise suppression, automatic gain control, etc.) to enhance audio quality. This approach enables a dynamic multi-microphone system where the built-in microphones of the integrated video conferencing system work in tandem with the microphones of users' devices. Additionally, the integrated video conferencing system receives the benefit of multiple additional audio inputs using the general-purpose hardware of the users' devices.

A critical consideration when implementing an integrated video conferencing system is ensuring the selection of a high-quality audio input from among the multiple possible audio streams generated by the various audio input devices in use. Existing approaches combine the audio from all audio input devices to generate an audio output, combining low-quality audio with high-quality audio which results in poor audio output quality. Some existing approaches may naively select one of the audio input sources based on threshold criteria such as signal strength or signal-to-noise ratio. But such approaches do not ensure quality, since these analog characterizations of audio input may not correlate with audio quality.

Example systems and methods for implementing audio input selection and mixing using AI are disclosed to address these shortcomings. In some examples, an AI-driven system can intelligently select and/or mix the highest-quality audio signals from among multiple audio input signals, which can ensure high quality audio delivery to remote participants. The techniques disclosed herein can be used to identify audio sources from among both the integrated video conferencing system microphones and users' device microphones, to significantly enhance the audio experience for remote attendees.

In an example method provided to illustrate certain concepts, consider an integrated video conference system installed in a conference room that is joined to a video conference hosted by a video conference provider. The video conference may include a number of participants including the users of the integrated video conference system as well as a number of participants using remote client devices. The integrated video conference system may include one or more microphones with the integrated video conference system such as built-in microphones; in this respect the integrated video conference system can function as an audio capture device. At the same time, a number of participants may use the microphones of their personal user devices (e.g., smartphones) as audio capture devices.

The integrated video conference system receives audio streams from each of the audio capture devices connected to it to provide audio streams for the video conference, where each audio stream includes a number of sequential audio frames. The integrated video conference system also receives audio quality measures from each of these audio capture devices based on its respective audio stream. For example, each audio capture device can provide its audio stream to an artificial intelligence (AI) model, such as a machine learning (ML) model, that is trained to output one or more selection features that correspond to an audio quality measure. The ML model may output, for each audio frame, a scalar value representing the audio quality for the frame based on factors such as signal-to-noise ratio or reverberation level.

The integrated video conference system then generates a selection probability for each audio stream by normalizing the received selection features into a single, comparable probability value using, for example, a softmax normalization procedure. The integrated video conference system can then select the highest quality audio stream(s) from the received audio streams based on the selection probabilities and generate an output audio stream by aggregating the highest quality audio streams.

Although the example of integrated video conferencing systems has been described above, the disclosed techniques can be similarly applied in various contexts. For example, any multi-channel or multi-microphone audio systems can be used in concert with audio input selection and mixing using AI to obtain improved audio quality. Additional examples include wearable microphone systems (e.g., hearing aid and assistive listening devices), broadcast or recording setups, surround sound home theater systems, automotive hands-free communication setups, or spatial audio capture systems for augmented reality (“AR”) or virtual reality (“VR”) applications.

Systems and methods according to the present disclosure provide significant improvements in the technical fields of audio engineering and artificial intelligence. The disclosed methods can be used to perform multi-microphone selection and mixing of the selected input sources intelligently to deliver higher quality audio than was previously achievable. Moreover, the particular ML model configuration constitutes an improvement over existing systems, which has general applicability even outside the audio engineering space, as will be described in more detail below. In particular, the disclosed ML model can dramatically lower computational costs such that it can be executed on user devices and other client devices acting as audio capture devices to enable distributed computation of the information needed to select high-quality audio inputs. For example, the “ResNet” blocks included in some examples of the ML model allow for a “deeper” network with more layers, enhancing accuracy and improving the model's ability to generalize across different data distributions. Likewise, the gated recurrence unit (“GRU”) layer included in some examples of the ML model can enable smoother audio output as well as enabling the incorporation of mode information about audio input history when assessing the quality of a given audio input.

These illustrative examples are given to introduce the reader to the general subject matter discussed herein, and the disclosure is not limited to these examples. The following sections describe various additional non-limiting examples of systems and methods for audio input selection and mixing using AI.

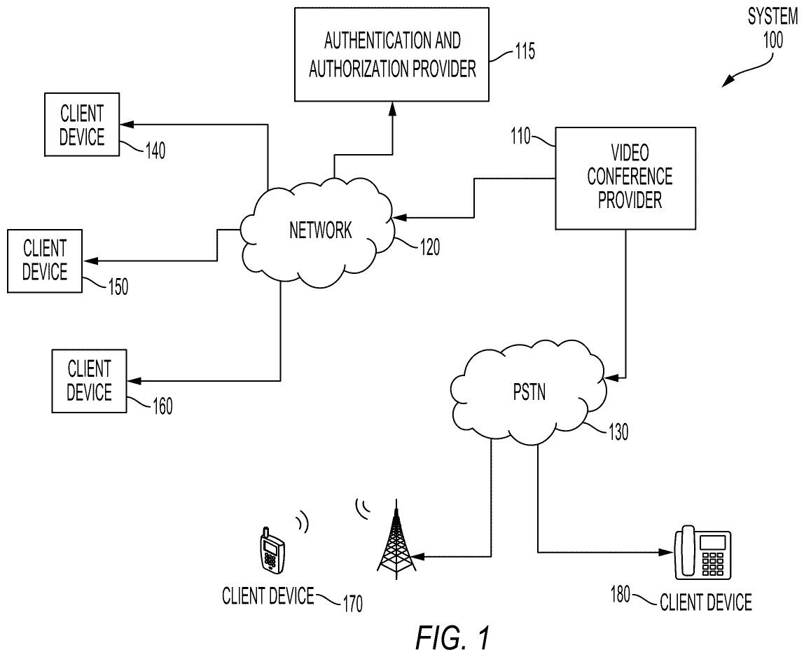

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

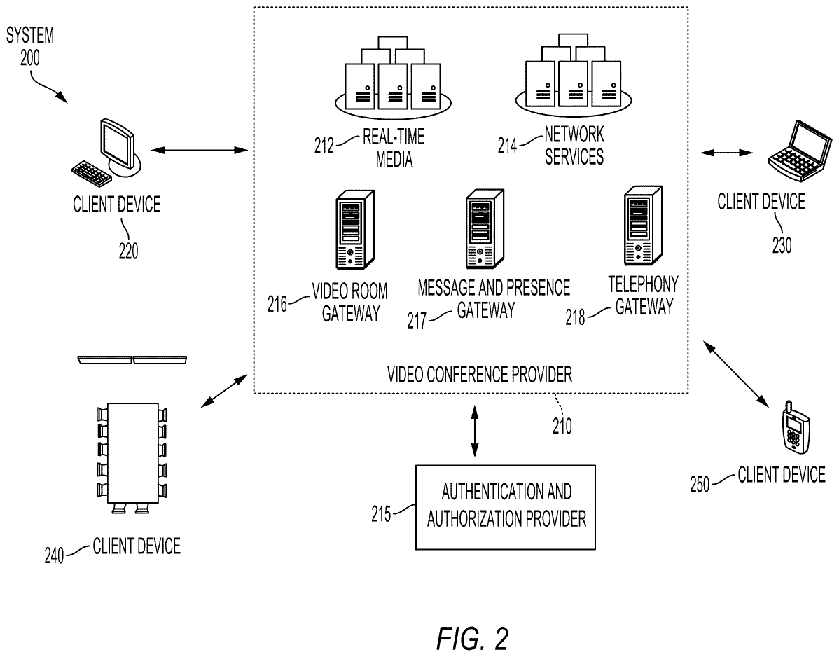

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones, and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

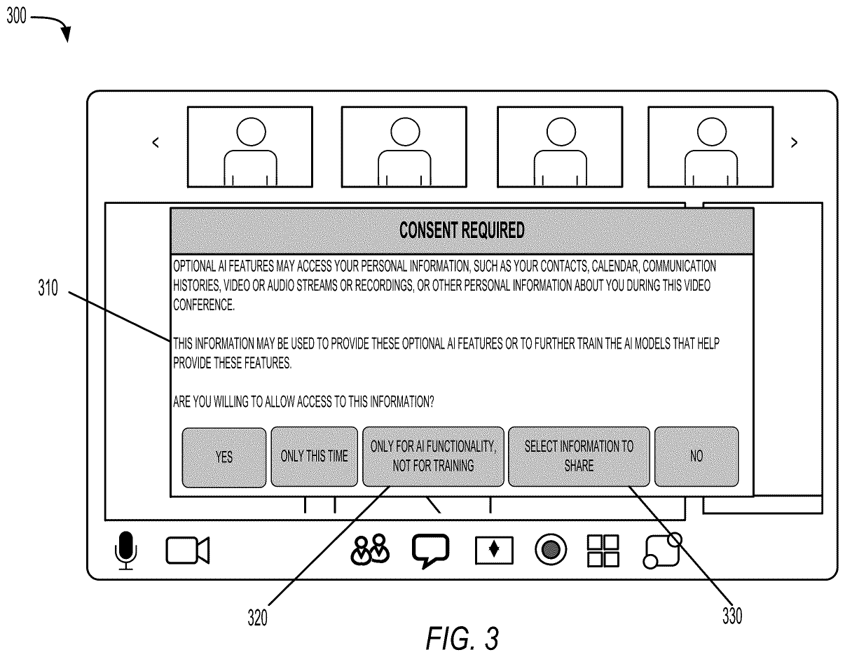

Turning next to FIG. 3, FIG. 3 shows an example user interface 300 that may be used in some example systems configured for audio input selection and mixing using artificial intelligence, according to some aspects of the present disclosure. In some examples according to the present disclosure, a user may select an option to use one or more optional AI features available from a virtual conference provider. The use of these optional AI features may involve providing the user's personal information to the ML models underlying the AI features. The personal information may include the user's contacts, calendar, communication histories, video or audio streams, recordings of the video or audio streams, transcripts of audio or video conferences, or any other personal information available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying ML models.

Before capturing and using any such information, whether to provide optional AI features or to provide training data for the underlying ML models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any ML model. Additionally, these optional AI features are turned off by default-account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying ML models. In addition, the user is presented with the option 330 to select which types of information may be shared and for what purpose, such as to provide the AI functionality or to allow use for training underlying ML models.

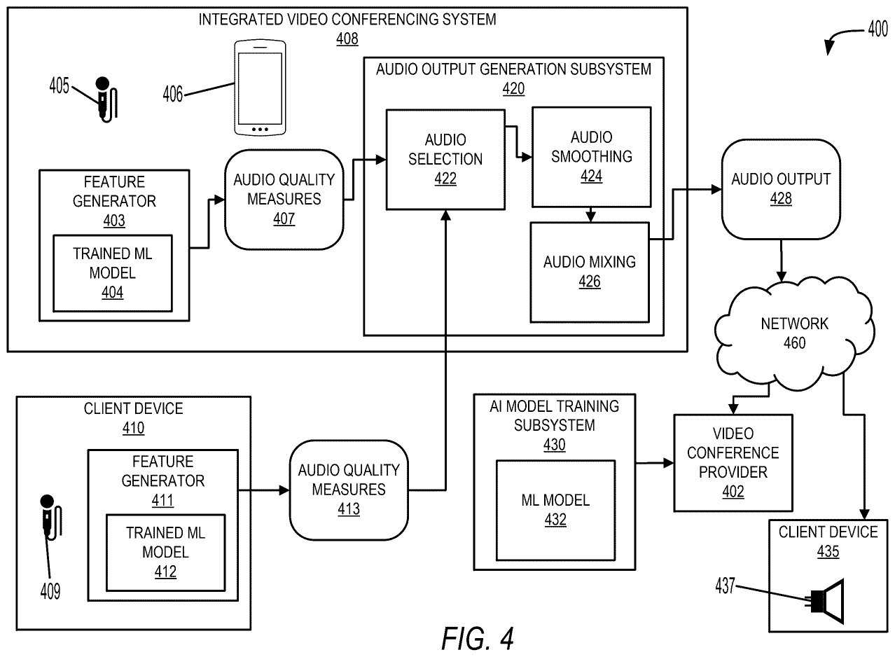

Referring now to FIG. 4, FIG. 4 shows an example of a system 400 implementing audio input selection and mixing using artificial intelligence, according to some aspects of the present disclosure. System 400 includes a remote client device 435 and integrated video conferencing system 408 communicatively coupled with video conference provider 402 over a network 460. Network 460 may include the Internet, public networks, private networks, or combinations thereof.

The video conference provider 402 may be a server or collection of servers, including a combination of privately or cloud-hosted devices. Video conference provider 402 may be similar, in some respects, to the video conference providers 110, 210 described above with respect to FIGS. 1 and 2.

The integrated video conferencing system 408, such as the “Zoom Room” produced by Zoom Communications, Inc., can provide a dedicated environment equipped for multi-participant video conferencing in one location such as a conference room with a shared camera or cameras capturing video conference participants. The integrated video conferencing system 408 may include a combination of hardware and software components. The integrated video conferencing system hardware may include devices for executing an integrated video conferencing system client application, a controller application, or other software or firmware for implementing integrated video conferencing system 408 functionality such as a laptop, desktop, dedicated hardware device, and so on. The integrated video conferencing system hardware may be configured to install and execute the integrated video conferencing system client application.

High-level video conferencing functionality can be provided by the integrated video conferencing system client application such as hosting video conferences or joining existing video conferences. The controller application can provide additional video conferencing user-facing functionality such as starting or ending video conferences, muting or unmuting microphones, and providing user interfaces for video conference configurations and settings.

For example, the controller application can provide interfaces or graphical user interfaces (“GUIs”) for setting up video conferences, starting and stopping video conferences, microphone controls (e.g., controls for muting or unmuting microphones), camera controls, and so on, represented in FIG. 4 as user interface 406. User interface 406 may be any smartphone, tablet, laptop, etc. suitable for operating the integrated video conferencing system 408 and conducting video conferences using the connected input and output devices, as well as the peripheral client devices in use as microphones, such as audio capture device 410.

An audio capture device 410 is communicatively coupled with the integrated video conferencing system 408. For example, the audio capture device 410 may be used as an external microphone for the integrated video conferencing system 408 during a video conference as described above. The audio capture device 410 and the integrated video conferencing system 408 may exchange data or other information via a wireless communication channel such as the Internet or over a local area network such as a LAN, WiFi, Bluetooth, mesh, or other suitable network method or protocol. In this example, the audio capture device 410 may be used in a conference room along with the integrated video conferencing system 408 installed in the conference room.

The audio capture device 410 and client device 435 may be any type of device capable of executing the appropriate client software for video conferencing, including audio input selection and mixing using artificial intelligence. For example, the audio capture device 410 and client device 435 may be laptops, desktops, smartphones, tablets, internet protocol (IP) phones, and so on. The audio capture device 410 includes a microphone 409, which may be an internal, embedded microphone or an external microphone.

The integrated video conferencing system 408, audio capture device 410, and client device 435 may be joined to a video conference hosted by the video conference provider 402. For the audio capture device 410 with microphone 409 and integrated video conferencing system 408 with primary microphone 405, the input audio streams originate from multiple sources, containing the same content but varying in audio quality. For such a multi-microphone system, multiple microphones may be capturing the speech from the same speaker, the same music, or other audio, with varying degrees of intensity and fidelity.

The integrated video conferencing system 408 and audio capture device 410 and include feature generators 403, 411, respectively, for generating audio quality measures for locally connected audio input devices. The feature generators 403, 411 can be used to locally determine an absolute measure of audio quality using a trained ML model 404, 412 in real-time. In some examples, some or all functions of the feature generators 403, 411 can likewise be performed by the audio output generation subsystem 420 or components of the video conference provider 402. That is, selection feature generation may be performed by the integrated video conferencing system 408, the audio capture device 410 or, alternatively, by downstream components such as the audio output generation subsystem 420 or components of the video conference provider 402. FIG. 4 depicts an example in which selection feature generation is performed by the feature generator 411 of the audio capture device 410 and the feature generator 403, which is a component of the integrated video conferencing system 408 such as a sub-component of the video conferencing system client application or controller application.

More generally, a multi-channel or multi-microphone audio systems used in concert with audio input selection and mixing using AI may include a number of audio capture devices with embedded (e.g., internal) or external microphones. For example, a multi-microphone system could include a combination of audio capture devices with microphones, wearable microphone systems (e.g., hearing aid and assistive listening devices), broadcast or recording setups, surround sound home theater systems, automotive hands-free communication setups, spatial audio capture systems for augmented reality (“AR”) or virtual reality (“VR”) applications, and so on. In these examples, a feature generator, included a trained ML model, may be a component of the audio capture device. In some examples, when the processing power or memory of the audio capture device is constrained (e.g., smart ear buds or hearing aid), the audio capture device may operate in concert with an associated client device (e.g., a laptop or smartphone) which executes the feature generator component.

The integrated video conferencing system 408 includes an audio output generation subsystem 420. While the audio output generation subsystem 420 is shown as component of the integrated video conferencing system 408, in other examples the audio output generation subsystem 420 can be a standalone component communicatively coupled over network 460, a component of the video conference provider 402, or an application executed by the audio capture device 410, such as the video conference client application. For example, the integrated video conferencing system 408 and all other associated audio capture devices (e.g., 410) may include only the feature generation components 403, 411 and all downstream processing by the components of the audio output generation subsystem 420 can be performed remotely at the video conference provider 402 or other suitable server.

The audio output generation subsystem 420 includes a number of components for selecting and aggregating audio input signals. Aggregation operations may include smoothing, mixing, and so on. The components of the audio output generation subsystem 420 may be implemented in hardware, software, or a combination thereof. Software components may be hosted on physical servers, virtual machines, cloud computing instances, or a combination thereof. The components of the audio output generation subsystem 420 are shown in FIG. 4 grouped together for clarity, but in various examples may include numerous separate, communicatively coupled components.

In this example, the integrated video conferencing system 408 has an attached microphone 405 and the audio capture device 410, used as an external microphone for the integrated video conferencing system 408, has an internal microphone 409. The feature generators 403, 411 can receive an audio input from microphones 405, 409 and process the audio input by trained ML models 404, 412 to output measures of the audio input quality. These are represented in FIG. 4 as audio quality measures 407, 413. The audio quality measures 407, 413 are output to the audio selection component 422 of the audio output generation subsystem 420.

Audio quality measures 407, 413 may be determined for each audio frame of the captured audio streams. The audio quality measures 407, 413 may be, for example, scalar confidence scores such as a confidence score indicating the likelihood that speech is present or clearly captured in each audio frame, a signal-to-noise ratio estimate derived from the spectral features of each microphone channel, a reverberation level indicator, and so on. The audio quality measures 407, 413 may be output as matrices with a number of corresponding to the number of selection features, and each column corresponding to an audio frame for the audio stream.

The audio quality measures 407, 413 are provided to the audio output generation subsystem 420. The received audio quality measures 407, 413 can be normalized by the audio selection component 422 of the audio output generation subsystem 420 to generate a probability that the respective audio input component is high quality. For example, the audio selection component 422 may apply a normalization function such as the softmax function to convert an N-component vector for an audio stream and audio frame to a probability. The audio selection component 422 can then select a highest quality portion of the various audio inputs (e.g., the top 2 audio inputs or the top 10% of inputs).

The highest quality portion of the various audio inputs can then be aggregated to produce an audio output 428 as an audio output stream. The aggregation may involve audio smoothing 424, audio mixing 426, as shown, as well as other aggregation operations or audio engineering functions. The audio output 428 can then be output to the video conference provider 402 to be dispatched to the remote client device 435 for playback over audio output device 437. For example, the audio smoothing component 424 may apply a temporal filter to prevent abrupt transitions when the highest quality audio streams change and the generated audio output 428 is constituted from different input audio streams. The audio mixing component 426 can blend the smoothed signals from the various audio input sources using weighted coefficients derived from the audio quality measures or selection probabilities. For instance, the audio output 428 may be generated by combining 70% of the signal from a the primary microphone 405 and 30% from the user client device microphone 409.

In some examples, the highest quality portion of the various audio streams may be provided to the video conference provider 402 as separate audio streams instead of or in parallel with smoothing and mixing. For example, the video conference provider 402 may perform mixing, spatial audio rendering, etc. remotely rather than by the integrated video conferencing system 408. This may be done to improve audio quality for the remote client device 435. In another example, the video conference provider 402 may retain the audio streams for archival purposes, such as generating per-speaker transcripts, isolating individual speaker channels for compliance review, and so on.

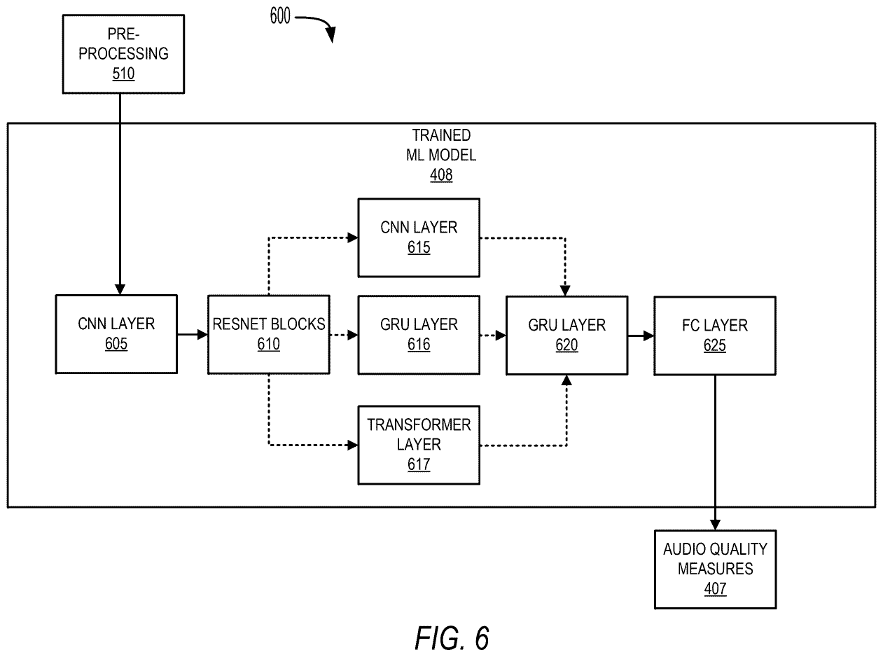

The video conference provider 402 also includes ML model training subsystem 430 that can be configured to train the ML model 432. The ML model 432 thus trained can be exported to the audio capture device 410 and integrated video conferencing system 408 to be used locally as trained ML models 404, 412 to generate the audio quality measures 407, 413. The ML model training subsystem 430 may include components such as a data processing module to preprocess training data, a model optimization module to adjust parameters of the ML model components described below in FIG. 6 using gradient-based learning and other feedback mechanisms, a validation module to evaluate model performance, and so on. The ML model training subsystem 430 is shown as a standalone component (e.g., hosted in a cloud computing environment or provided by a cloud service provider) but may likewise be a component of the video conference provider 402. For example, the model training subsystem 430 may be implemented as a standalone component, including one or more super computers or one or more servers configured for ML model training with graphics processing units (“GPUs”), which may execute training operations independently of the video conference provider 402.

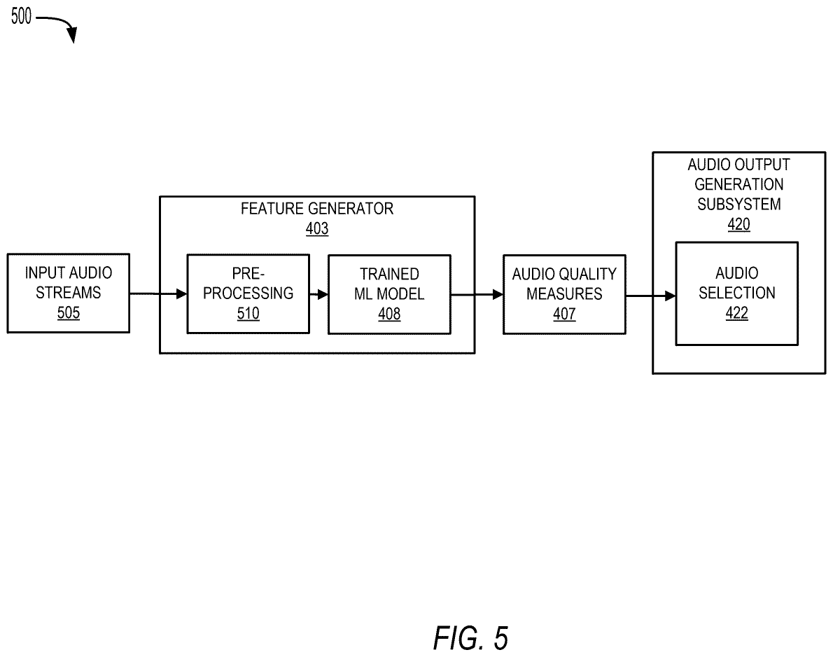

Referring now to FIG. 5, FIG. 5 shows an example implementation 500 of the feature generator 403 of FIG. 4, according to some aspects of the present disclosure. Certain examples of the present disclosure relate to selecting and/or mixing high-quality audio signals from the available sources. The multi-source audio can be processed either independently, using a centralized architecture, or interactively, depending on the task requirements. For example, in a distributed system where each device processes its own audio, independent processing is generally preferred. In the example shown in FIG. 4, each audio capture device 410 or the integrated video conference system 408 with an audio input in use can execute a feature generator 403, 411. FIG. 5 depicts an example implementation of a feature generator such as the feature generator 403 of audio capture device 410. However, as described above, in some examples, the feature generator 403 may be a component of the audio output generation subsystem 420, or a standalone component. Various configurations are possible.

The input audio streams 505 may include multiple concurrent audio channels captured from different audio input sources within a video conferencing environment, such as the microphones 405, 409 shown in FIG. 4. Each input audio stream of the input audio streams 505 may be segmented into time-aligned audio frames, such as a 20 millisecond windows started at 10 millisecond intervals such that the audio frames overlap in time. In another example, the 20 millisecond window may start at 20 millisecond intervals such that the start and stop time of each audio frame aligns time. Corresponding audio frames across the input audio streams 505 may be time-aligned and can be compared or combined by downstream processing components.

In the signal preprocessing component 510 of feature generator 403, the input audio streams 505 can be processed audio frame by audio frame. In some examples, the input audio streams 505 may be processed in larger blocks or segments spanning multiple frames to capture longer temporal context or processed continuously using a streaming architecture that maintains state across successive frames. In some examples, the preprocessing component 510 may operate on entire input audio streams 505 at once.

The signal preprocessing component 510 can transform the input audio streams 505 into spectral features or frequency domain representations, such as short-time Fourier transform (STFT) or Mel spectrogram representations. For example, the signal preprocessing component 510 can apply an STFT to each audio frame, generating a representation that captures the magnitude of frequency components throughout the duration of the audio frame. As another example, the signal preprocessing component 510 may compute a Mel spectrogram by applying filters spaced according to the Mel scale to the STFT output. The output of the signal preprocessing component 510 may be, for example, a vector with components corresponding to frequency bins or Mel bands.

The spectral features output by the signal preprocessing component 510 can be provided to the trained ML model 404 to generate audio quality measures 407. The audio quality measures 407 may be, for example, selection features that can be used to generate selection probabilities to determine the highest quality input audio streams. In some examples, the selection features may be a numerical representation of an absolute prediction of the audio quality for a given audio input signal. In this respect, the prediction can be absolute in the sense that it can be output without reference to other audio input signals. For example, a high quality audio input may result in a selection feature of 1000, while a low quality audio input may result in a selection feature of 1. In some examples, each feature generator 403 can output numerous audio quality measures 407 for a given audio stream. For example, the feature generator 403 may output separate audio quality measures for each of speech presence likelihood, signal-to-noise ratio, or reverberation level.

The audio quality measures 407 can be normalized using, for example, a softmax function by the audio selection component 422 component of the audio output generation subsystem 420 to compute selection probabilities that sum to 1. The selection probabilities can correspond to the probability that a given audio input signal is a high-quality audio input signal. The selection probabilities can be used to select one or more of the audio input signals based on a predetermined number of input signals or a predetermined threshold probability.

The trained ML model 404 may include one or more deep learning neural networks. For example, the trained ML model 404 may include a convolutional neural network (CNN) that processes spectral data output by the preprocessing component 510 spectrogram as a two-dimensional image and applies convolutional filters to detect patterns. An example implementation of the trained ML model 404 is shown in FIG. 6.

Referring now to FIG. 6, FIG. 6 shows an example implementation 600 of the trained ML model 404 of FIGS. 4 and 5, according to some examples of the present disclosure. The trained ML model 404 receives the preprocessed audio streams from the preprocessing component 510 of FIG. 5 and generates the audio quality measures 407, also referred to as selection features. For example, the preprocessing component 510 may output vectors concatenated to form a matrix with rows corresponding to frequency bins or Mel bands and columns corresponding to sequential audio frames. These spectral features can be processed by a convolutional neural network (CNN) layer 605 to reduce the number of dimensions used to represent the feature. At the same time, the CNN layer 605 can increase the number of channels used to represent the input feature. For example, the CNN layer 605 may receive a matrix representing a Mel spectrogram of 300 audio frames that has 300 columns and 80 Mel bands as rows. The CNN layer 605 can apply convolutional and pooling processes that reduce the dimensions to 75 time dimensions, 20 frequency bands while expanding to 64 channels, resulting in a 75×20×64 3-dimensional matrix.

The output of the CNN layer 605 is then provided to a module that contains one or more residual network (“ResNet”) blocks 610. Each ResNet block may include one or more CNN layers, a batch normalization layer, an activation layer (e.g., Rectified Linear Unit (“ReLU”)), and a skip or residual connection that can add the ResNet input to the ResNet output to improve gradient flow and enable deeper network training. The one or more ResNet blocks 610 can improve training dynamics and enable the construction of very deep networks. Furthermore, the one or more ResNet blocks can contribute to avoidance of the vanishing gradient problem during training, enabling even deeper neural networks (e.g., more neural network layers). Consequently, the model can achieve higher accuracy on complex tasks without requiring exponentially more data. Moreover, the one or more ResNet blocks 610 in conjunction with the CNN layer 605 can boost the network's ability to generalize and extract hierarchical features. As mentioned above, in some examples, the one or more ResNet blocks 610 may each include skip or residual connections. A skip connection can bypass one or more CNN layers internal to the ResNet block by directly adding the input to the output (e.g., identity mapping) which can reduce the vanishing gradient problem during training. Any suitable number of ResNet blocks 610 can be selected in accordance with the target application or accuracy. For instance, some examples may use four ResNet blocks.

After the one or more ResNet blocks 610, at least one of a CNN layer 615, a gated recurrent unit (GRU) layer 616, or a transformer layer 617 can be used to further reduce the dimensionality of the input audio data during processing to further conserve computational resources on resource-constrained audio capture devices such as audio capture device 410 of FIG. 4. A GRU is a type of recurrent neural network (RNN) that uses “gates” to capture sequential dependencies while also mitigating vanishing gradients during training. In this regard, gates can refer generally to learned mechanisms or trainable functions parameterized by weights that can dynamically control information flow in a neural network based on received input as well as hidden state. A GRU may include, for example, an update gate and a reset gate that can be trained to control the influence of historical data on the model output. A transformer can refer generally to a deep learning architecture (e.g., deep neural network) that uses self-attention mechanisms in lieu of recurrence. In FIG. 6, a dashed line is used to indicate that one or more of the layers 615, 616, or 617 may be included in various example implementations.

To reduce the fluctuations in the results, a GRU layer 620 receives the output of the previous components. The GRU layer 620 can receive a time sequence of inputs and be trained to smooth the output of the previous components by incorporating a significant portion of historical audio input data into its output.

A fully-connected (“FC”) layer 625 receives the output of the GRU layer 620. The FC layer 625 can be trained to synthesize the results of the preceding components and output the selection feature, also referred to as the audio quality measure. In some examples, the FC layer 625 is a neural network layer in which each neuron is connected to every neuron in the previous layer. As described above, the FC layer 625 can be trained to output a number of absolute measures of audio quality, or selection features, as a vector.

A component implementing a probability distribution computation (e.g., the softmax function) can convert the output selection features from feature generators 403, 411 to obtain selection probabilities from the selection features. For example, the component may include a softmax activation module that processes the selection features by exponentiating and normalizing them to generate a probability distribution, enabling selection of audio inputs based on relative feature importance using a predefined number of audio input streams or threshold portion of audio input streams.

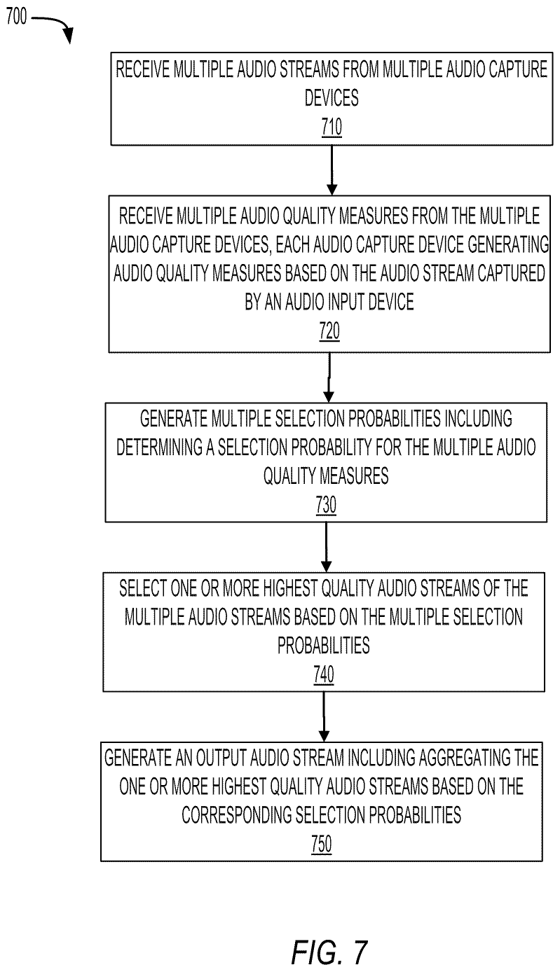

Referring now to FIG. 7, FIG. 7 shows a flowchart of an example method 700 for implementing audio input selection and mixing using artificial intelligence, according to some aspects of the present disclosure. The description of the method 700 in FIG. 7 will be made with reference to FIGS. 4-6, however any suitable system according to this disclosure may be used, such as the example systems 100 and 200, shown in FIGS. 1 and 2. It should be appreciated that method 700 provides a particular method for providing audio input selection and mixing using artificial intelligence. Other sequences of operations may also be performed according to alternative examples. For example, alternative examples of the present disclosure may perform the steps outlined below in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of a device hosting a feature generator and the audio output generation subsystem 420 together, such as integrated video conferencing system 408, but other configurations are possible. One of ordinary skill in the art would recognize many variations, modifications, and alternatives.

The method 700 may include block 710. At block 710, a computing system, such as integrated video conferencing system 408, receives multiple audio streams from multiple audio capture devices. For example, a video conference may involve the integrated video conferencing system 408 with several connected microphones and an associated client device for operating the integrated video conferencing system 408 and a user device with a microphone, acting as an audio capture device. Each of these audio capture devices may capture an audio stream. In this example, the user device is considered a component of the integrated video conferencing system 408.

At block 720, the computing system receives multiple audio quality measures from the multiple audio capture devices, each audio capture device generating audio quality measures based on the audio stream captured by an audio input device. that is, selection feature generation may be performed locally on each audio capture device. In some examples, selection feature generation may be performed by the computing system. In that case, the computing system may receive unprocessed audio streams from the audio capture devices. To generate the selection features, the audio capture devices (or computing system) can process the captured audio streams using an ML model trained to output measures of the audio input quality for each respective audio input. For example, the trained ML model described in FIG. 5 can be used to generate the measures (e.g., selection features) for each audio stream or portions thereof (e.g., one or more audio frames).

At block 730, the computing system generates multiple selection probabilities including determining a selection probability for the multiple audio quality measures. For example, the computing system can receive selection features for an audio frame or audio frames and normalize the measures of audio quality encoded therein. For example, the audio quality measures computed for each of the input audio streams can be combined using a normalization operation (e.g., the softmax activation function) to yield probabilities that correspond to the likelihood that each respective audio input source is of high-quality.

At block 740, the computing system selects one or more highest quality audio streams of the multiple audio streams based on the multiple selection probabilities. For example, the computing system can select a highest quality portion of the multiple audio streams using the normalized measures determined in block 730. For example, the two audio streams having the two highest probabilities may be selected. Alternatively, the top 10% of probabilities may be selected. Alternatively, only probabilities above a specified threshold value may be selected (e.g., greater than 75% probability of high quality).

At block 750, the computing system generates an output audio stream including aggregating the one or more highest quality audio streams based on the corresponding selection probabilities. For example, the computing system can aggregate the multiple audio streams to produce an audio output stream. The highest quality portion of the plurality of audio inputs may be combined using aggregation techniques such as audio smoothing, mixing, filtering, alignment, averaging, and so on.

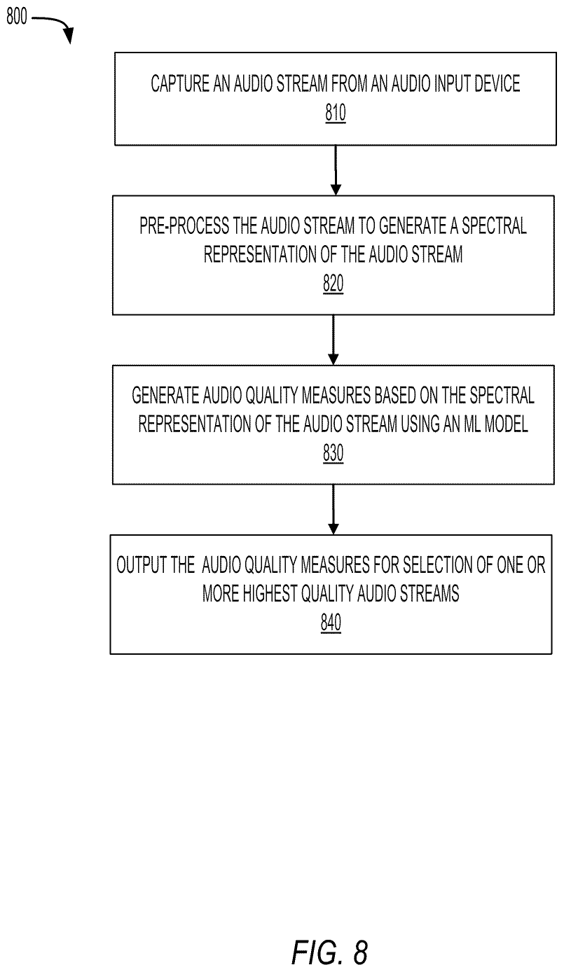

Referring now to FIG. 8, FIG. 8 shows another flowchart of an example method 800 for implementing audio input selection and mixing using artificial intelligence, according to some aspects of the present disclosure. The description of the method 800 in FIG. 8 will be made with reference to FIGS. 4-6, however any suitable system according to this disclosure may be used, such as the example systems 100 and 200, shown in FIGS. 1 and 2. It should be appreciated that method 800 provides a particular method for providing audio input selection and mixing using artificial intelligence. Other sequences of operations may also be performed according to alternative examples. For example, alternative examples of the present disclosure may perform the steps outlined below in a different order. Moreover, the individual operations illustrated by method 800 may include multiple sub-operations that may be performed in various sequences as appropriate to the individual operation. Furthermore, additional operations may be added or removed depending on the particular applications. Further, the operations described in method 800 may be performed by different devices. For example, the description is given from the perspective of a device generating audio quality measures such as the audio capture device 410 or a component of the integrated video conferencing system 408 of FIG. 4, but other configurations are possible. One of ordinary skill in the art would recognize many variations, modifications, and alternatives.

The method 800 may include block 810. At block 810, a computing system, such as a device generating audio quality measures such as the audio capture device 410 or a component of the integrated video conferencing system 408, captures an audio stream from an audio input device. For example, a laptop participating in a video conference as a user device providing an external microphone for an integrated video conferencing system may capture an audio stream from its built-in microphone array. The audio stream can be digitized at a configured sample rate and added to sequential audio frame data structures.

At block 820, the computing system preprocesses the audio stream to generate a spectral representation of the audio stream. For example, the computing system may apply a short-time Fourier transform (STFT) to each frame of the audio stream to convert the time-domain samples into a frequency-domain representation that captures the magnitude of each frequency component present in that frame. In some examples, the computing system may further process the STFT output by applying a Mel-scale filter bank to generate a Mel spectrogram. In a Mel spectrogram, the frequency information can be compressed into perceptually relevant bands that more closely correspond to human auditory sensitivity.

At block 830, the computing system generates audio quality measures based on the spectral representation of the audio stream using an ML model. For example, the ML model may include components such as CNN layers, GRU layers, transformer layers, FC layers, and so on. The ML model may be trained using supervised or unsupervised training methods to generate audio quality measures, also referred to as selection features, which characterize the audio quality of the audio stream. For example, the ML model may be trained using supervised learning on a dataset of audio frames labeled with ground-truth quality scores scored by human annotators who rate portions of audio training data for characteristics such as clarity, noise level, and reverberation.

At block 840, the computing system outputs the audio quality measures for selection of one or more highest quality audio streams. For example, a downstream system such as a video conference provider or the audio output generation subsystem 420 of FIGS. 4 and 5 can collect audio quality measures from audio capture devices to select one or more highest quality audio streams. Determination of selection probabilities may be performed by the downstream components. For instance, in an example in which each of three audio capture devices outputs one audio quality measure, the softmax function may convert the audio quality measures into three normalized selection probabilities for the audio frame.

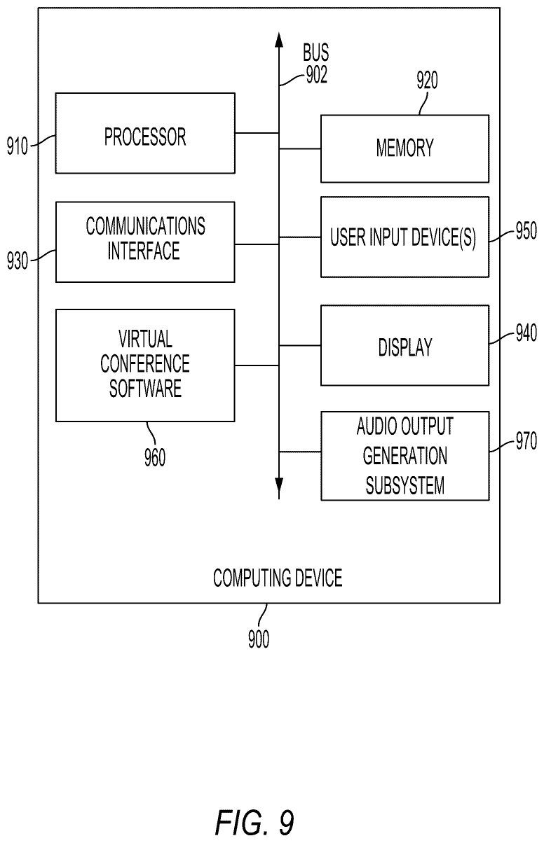

Referring now to FIG. 9, FIG. 9 shows an example computing device 900 suitable for use in example systems or methods for providing audio input selection and mixing using artificial intelligence, according to some examples of the present disclosure. The example computing device 900 includes a processor 910 which is in communication with the memory 920 and other components of the computing device 900 using one or more communications buses 902, including the audio output generation system 970. The audio output generation system 970 may be similar to the audio output generation subsystem 420 as described above. In other examples, the computing device 900 may correspond to the audio capture device 406 or a component of the integrated video conferencing system 408.

The processor 910 is configured to execute processor-executable instructions stored in the memory 920 to perform one or more methods for audio input selection and mixing using artificial intelligence according to different examples, such as part or all of the example method 700 described above with respect to FIG. 7. The computing device 900, in this example, also includes one or more user input devices 950, such as a keyboard, mouse, touchscreen, microphone, etc., to accept user input. The computing device 900 also includes a display 940 to provide visual output to a user.

In addition, the computing device 900 includes virtual conferencing software 960 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4).

Example 1 is a method, may include: receiving, by an integrated video conference system, a plurality of audio streams from a plurality of audio capture devices; receiving, by the integrated video conference system, a plurality of audio quality measures from the plurality of audio capture devices, each audio capture device generating audio quality measures based on the audio stream captured by an audio input device; generating, by the integrated video conference system, a plurality of selection probabilities may include determining a selection probability for the plurality of audio quality measures; selecting, by the integrated video conference system, one or more highest quality audio streams of the plurality of audio streams based on the plurality of selection probabilities; and generating, by the integrated video conference system, an output audio stream may include aggregating the one or more highest quality audio streams based on the corresponding selection probabilities.

Example 2 is the method as example 1 describes, where: the plurality of audio capture devices may include: a first audio capture device that is a component of the integrated video conference system, first audio capture device may include a first microphone; and a second audio capture device, the second audio capture device being a user device may include a second microphone and communicatively coupled with the integrated video conference system via a wireless communication channel.

Example 3 is the method as either of examples 1 or 2 describe, where generating the audio quality measures based on the audio stream captured by the audio input device may include providing the audio stream to a machine learning (ML) model trained to output one or more selection features.

Example 4 is the method as any of examples 1-3 describe, where each selection feature may include a scalar audio value corresponding to an audio quality measure.

Example 5 is the method as any of examples 1-4 describe, where providing the audio stream to the ML model may include preprocessing the audio stream comprising applying a Short-Time Fourier Transform (STFT) using a predefined window length.

Example 6 is the method as any of examples 1-5 describe, where providing the audio stream to the ML model further may include computing a Mel spectrogram based on the STFT.

Example 7 is the method as any of examples 1-6 describe, where: each audio stream may include a plurality of audio frames; and the audio quality measure based on the audio stream captured by the audio input device is generated for each audio frame of the audio stream.

Example 8 is the method as any of examples 1-7 describe, where: aggregating the one or more highest quality audio streams based on the corresponding selection probabilities may include: aggregating one or more first highest quality audio streams for a first audio frame based on corresponding first selection probabilities; and aggregating one or more second highest quality audio streams for a second audio frame based on corresponding second selection probabilities; and the method further may include: detecting a difference between the one or more first highest quality audio streams and the corresponding first selection probabilities and the one or more second highest quality audio streams and the corresponding second selection probabilities; and combining the one or more second highest quality audio streams using the corresponding second selection probabilities as linear weights using a temporal smoothing technique.

Example 9 is the method as any of examples 1-8 describe, where the ML model may include a convolutional neural network (CNN) with at least four residual network blocks and a gated recurrent unit (GRU) layer.

Example 10 is the method as any of examples 1-9 describe, where generating the plurality of selection probabilities may include applying a softmax normalization to the plurality of audio quality measures.

Example 11 is the method as any of examples 1-10 describe, where aggregating the one or more highest quality audio streams based on the corresponding selection probabilities may include combining the one or more highest quality audio streams using the corresponding selection probabilities as linear weights.

Example 12 is the method as any of examples 1-11 describe, where the integrated video conference system is joined to a video conference hosted by a video conference provider, the video conference having multiple connected client devices including at least one remote client device.

Example 13 is a non-transitory computer-readable storage medium storing processor-executable instructions configured to cause one or more processors to: receive, by an integrated video conference system, a plurality of audio streams from a plurality of audio capture devices; receive, by the integrated video conference system, a plurality of audio quality measures from the plurality of audio capture devices, each audio capture device generating audio quality measures based on the audio stream captured by an audio input device; generate, by the integrated video conference system, a plurality of selection probabilities may include determining a selection probability for the plurality of audio quality measures; select, by the integrated video conference system, one or more highest quality audio streams of the plurality of audio streams based on the plurality of selection probabilities; and generate, by the integrated video conference system, an output audio stream may include aggregating the one or more highest quality audio streams based on the corresponding selection probabilities.

Example 14 is the non-transitory computer-readable storage medium as example 13 describes, where: the plurality of audio capture devices may include: a first audio capture device that is a component of the integrated video conference system, first audio capture device may include a first microphone; and a second audio capture device, the second audio capture device being a user device may include a second microphone and communicatively coupled with the integrated video conference system via a network.

Example 15 is the non-transitory computer-readable storage medium as either of examples 13 or 14 describe, where generating the audio quality measures based on the audio stream captured by the audio input device may include providing the audio stream to a ML model trained to output one or more selection features.

Example 16 is the non-transitory computer-readable storage medium as any of examples 13-15 describe, where providing the audio stream to the ML model may include preprocessing the audio stream comprising applying a STFT using a predefined window length.

Example 17 is a system may include: one or more non-transitory computer-readable media; and one or more processors communicatively coupled to the one or more non-transitory computer-readable media, the one or more processors configured to execute processor-executable instructions stored in the non-transitory computer-readable media to: receive, by an integrated video conference system, a plurality of audio streams from a plurality of audio capture devices; receive, by the integrated video conference system, a plurality of audio quality measures from the plurality of audio capture devices, each audio capture device generating audio quality measures based on the audio stream captured by an audio input device; generate, by the integrated video conference system, a plurality of selection probabilities may include determining a selection probability for the plurality of audio quality measures; select, by the integrated video conference system, one or more highest quality audio streams of the plurality of audio streams based on the plurality of selection probabilities; and generate, by the integrated video conference system, an output audio stream may include aggregating the one or more highest quality audio streams based on the corresponding selection probabilities.

Example 18 is the system as example 17 describes, where: the plurality of audio capture devices may include: a first audio capture device that is a component of the integrated video conference system, first audio capture device may include a first microphone; and a second audio capture device, the second audio capture device being a user device may include a second microphone and communicatively coupled with the integrated video conference system via a network.

Example 19 is the system as either of examples 17 or 18 describe, where generating the audio quality measures based on the audio stream captured by the audio input device may include providing the audio stream to a ML model trained to output one or more selection features.

Example 20 is the system as any of examples 17-19 describe, where providing the audio stream to the ML model may include preprocessing the audio stream comprising applying a STFT using a predefined window length.

What is claimed is:

1. A method, comprising:
receiving, by an integrated video conference system, a plurality of audio streams from a plurality of audio capture devices;
receiving, by the integrated video conference system, a plurality of audio quality measures from the plurality of audio capture devices, each audio capture device generating audio quality measures based on the audio stream captured by an audio input device;
generating, by the integrated video conference system, a plurality of selection probabilities comprising determining a selection probability for the plurality of audio quality measures;
selecting, by the integrated video conference system, one or more highest quality audio streams of the plurality of audio streams based on the plurality of selection probabilities; and
generating, by the integrated video conference system, an output audio stream comprising aggregating the one or more highest quality audio streams based on the corresponding selection probabilities.

2. The method of claim 1, wherein:
the plurality of audio capture devices comprise:
a first audio capture device that is a component of the integrated video conference system, first audio capture device comprising a first microphone; and
a second audio capture device, the second audio capture device being a user device comprising a second microphone and communicatively coupled with the integrated video conference system via a wireless communication channel.

3. The method of claim 1, wherein generating the audio quality measures based on the audio stream captured by the audio input device comprises providing the audio stream to a machine learning (ML) model trained to output one or more selection features.

4. The method of claim 3, wherein each selection feature comprises a scalar audio value corresponding to an audio quality measure.

5. The method of claim 3, wherein providing the audio stream to the ML model comprises preprocessing the audio stream comprising applying a Short-Time Fourier Transform (STFT) using a predefined window length.

6. The method of claim 5, wherein providing the audio stream to the ML model further comprises computing a Mel spectrogram based on the STFT.

7. The method of claim 3, wherein:
each audio stream comprises a plurality of audio frames; and
the audio quality measure based on the audio stream captured by the audio input device is generated for each audio frame of the audio stream.

8. The method of claim 7, wherein:
aggregating the one or more highest quality audio streams based on the corresponding selection probabilities comprises:
aggregating one or more first highest quality audio streams for a first audio frame based on corresponding first selection probabilities; and
aggregating one or more second highest quality audio streams for a second audio frame based on corresponding second selection probabilities; and
the method further comprises:
detecting a difference between the one or more first highest quality audio streams and the corresponding first selection probabilities and the one or more second highest quality audio streams and the corresponding second selection probabilities; and
combining the one or more second highest quality audio streams using the corresponding second selection probabilities as linear weights using a temporal smoothing technique.

9. The method of claim 3, wherein the ML model comprises a convolutional neural network (CNN) with at least four residual network blocks and a gated recurrent unit (GRU) layer.

10. The method of claim 1, wherein generating the plurality of selection probabilities comprises applying a softmax normalization to the plurality of audio quality measures.

11. The method of claim 1, wherein aggregating the one or more highest quality audio streams based on the corresponding selection probabilities comprises combining the one or more highest quality audio streams using the corresponding selection probabilities as linear weights.

12. The method of claim 1, wherein the integrated video conference system is joined to a video conference hosted by a video conference provider, the video conference having a plurality of connected client devices including at least one remote client device.

13. A non-transitory computer-readable storage medium storing processor-executable instructions configured to cause one or more processors to:
receive, by an integrated video conference system, a plurality of audio streams from a plurality of audio capture devices;
receive, by the integrated video conference system, a plurality of audio quality measures from the plurality of audio capture devices, each audio capture device generating audio quality measures based on the audio stream captured by an audio input device;
generate, by the integrated video conference system, a plurality of selection probabilities comprising determining a selection probability for the plurality of audio quality measures;
select, by the integrated video conference system, one or more highest quality audio streams of the plurality of audio streams based on the plurality of selection probabilities; and
generate, by the integrated video conference system, an output audio stream comprising aggregating the one or more highest quality audio streams based on the corresponding selection probabilities.

14. The non-transitory computer-readable storage medium of claim 13, wherein:
the plurality of audio capture devices comprise:
a first audio capture device that is a component of the integrated video conference system, first audio capture device comprising a first microphone; and
a second audio capture device, the second audio capture device being a user device comprising a second microphone and communicatively coupled with the integrated video conference system via a network.

15. The non-transitory computer-readable storage medium of claim 13, wherein generating the audio quality measures based on the audio stream captured by the audio input device comprises providing the audio stream to a ML model trained to output one or more selection features.

16. The non-transitory computer-readable storage medium of claim 15, wherein providing the audio stream to the ML model comprises preprocessing the audio stream comprising applying a STFT using a predefined window length.

17. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive, by an integrated video conference system, a plurality of audio streams from a plurality of audio capture devices;
receive, by the integrated video conference system, a plurality of audio quality measures from the plurality of audio capture devices, each audio capture device generating audio quality measures based on the audio stream captured by an audio input device;
generate, by the integrated video conference system, a plurality of selection probabilities comprising determining a selection probability for the plurality of audio quality measures;
select, by the integrated video conference system, one or more highest quality audio streams of the plurality of audio streams based on the plurality of selection probabilities; and
generate, by the integrated video conference system, an output audio stream comprising aggregating the one or more highest quality audio streams based on the corresponding selection probabilities.

18. The system of claim 17, wherein:
the plurality of audio capture devices comprise:
a first audio capture device that is a component of the integrated video conference system, first audio capture device comprising a first microphone; and
a second audio capture device, the second audio capture device being a user device comprising a second microphone and communicatively coupled with the integrated video conference system via a network.

19. The system of claim 17, wherein generating the audio quality measures based on the audio stream captured by the audio input device comprises providing the audio stream to a ML model trained to output one or more selection features.

20. The system of claim 19, wherein providing the audio stream to the ML model comprises preprocessing the audio stream comprising applying a STFT using a predefined window length.
